(19) United States
(12) Patent Application Publication
(10) Pub. No.: US 2025/0245891 A1
(43) Pub. Date: Jul. 31, 2025

(54) IMAGE EDITING METHOD AND APPARATUS, ELECTRONIC DEVICE, AND STORAGE MEDIUM

(71) Applicants: Beijing Zitiao Network Technology Co., Ltd., Beijing (CN); Lemon Inc., Grand Cayman (KY)

(72) Inventors: Tiancheng SHEN, Beijing (CN); Jun Hao LIEW, Singapore (SG); Long MAI, Los Angeles, CA (US); Lu QI, Beijing (CN); Jiashi FENG, Singapore (SG)

(21) Appl. No.: 19/013,214

(22) Filed: Jan. 8, 2025

(30) Foreign Application Priority Data
Jan. 25, 2024 (CN) 202410107990.2

(51) Int. Cl. G06T 11/60; G06V 10/77; G06V 10/774

(52) U.S. Cl. CPC G06T 11/60; G06V 10/7715; G06V 10/774; G06T 2200/24

(57) ABSTRACT

Embodiments of the present disclosure disclose an image editing method and apparatus, an electronic device, and a storage medium. The method includes: receiving an image to be edited and an editing theme; generating, by using a preset vision-language model, an editing instruction and an editing position corresponding to the editing instruction based on the image to be edited and the editing theme; and editing the image to be edited based on the editing instruction and the editing position, to obtain a target image.

### CROSS-REFERENCE TO RELATED APPLICATION

This application claims priority to Chinese Application No. 202410107990.2 filed in Jan. 25, 2024, the disclosure of which is incorporated herein by reference in its entirety.

### FIELD

Embodiments of the present disclosure relate to the field of image processing technologies, and in particular, to an image editing method and apparatus, an electronic device, and a storage medium.

### BACKGROUND

Existing image editing methods allow a user to easily edit an image simply by providing natural language instructions. However, these instructions need to be executable instructions to perform a specific operation on a specific object in the image. Currently, it is not yet possible to achieve image editing with respect to a relatively fuzzy editing theme.

### SUMMARY

Embodiments of the present disclosure provide an image editing method and apparatus, an electronic device, and a storage medium.

According to a first aspect, an embodiment of the present disclosure provides an image editing method. The method includes:
receiving an image to be edited and an editing theme;
generating, by using a preset vision-language model, an editing instruction and an editing position corresponding to the editing instruction based on the image to be edited and the editing theme; and
editing the image to be edited based on the editing instruction and the editing position, to obtain a target image.

According to a second aspect, an embodiment of the present disclosure further provides an image editing apparatus. The apparatus includes:
a receiving module configured to receive an image to be edited and an editing theme;
a generation module configured to generate, by using a preset vision-language model, an editing instruction and an editing position corresponding to the editing instruction based on the image to be edited and the editing theme; and
an editing module configured to edit the image to be edited based on the editing instruction and the editing position, to obtain a target image.

According to a third aspect, an embodiment of the present disclosure further provides an electronic device. The electronic device includes:
one or more processors; and
a storage apparatus configured to store one or more programs, where
the one or more programs, when executed by the one or more processors, cause the one or more processors to implement the image editing method described in any one of the embodiments of the present disclosure.

According to a fourth aspect, an embodiment of the present disclosure further provides a storage medium containing computer-executable instructions that, when executed by a computer processor, are used to perform the image editing method described in any one of the embodiments of the present disclosure.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic flowchart of an image editing method according to an embodiment of the present disclosure;

FIG. 2 is a schematic block diagram of an image editing method according to an embodiment of the present disclosure;

FIG. 3 is a schematic flowchart of constructing an instruction dataset in an image editing method according to an embodiment of the present disclosure;

FIG. 4 is a schematic block diagram of constructing an instruction dataset in an image editing method according to an embodiment of the present disclosure;

FIG. 5 is a schematic diagram of a structure of an image editing apparatus according to an embodiment of the present disclosure; and

FIG. 6 is a schematic diagram of a structure of an electronic device according to an embodiment of the present disclosure.

### DETAILED DESCRIPTION OF EMBODIMENTS

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” used herein and the variations thereof are an open-ended inclusion, namely, “include but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

This technical solution of the embodiment of the present disclosure involves receiving an image to be edited and an editing theme; generating, by using a preset vision-language model, an editing instruction and an editing position corresponding to the editing instruction based on the image to be edited and the editing theme; and editing the image to be edited based on the editing instruction and the editing position, to obtain a target image. By generating the creative editing instruction that is highly related to the image to be edited and the editing theme, and predicting the editing position corresponding to the editing instruction, it is possible to perform at least local creative editing on the image to be edited based on a fuzzy editing theme.

It can be understood that the data involved in the technical solutions (including, but not limited to, the data itself and the access to or use of the data) shall comply with the requirements of corresponding laws, regulations, and relevant provisions.

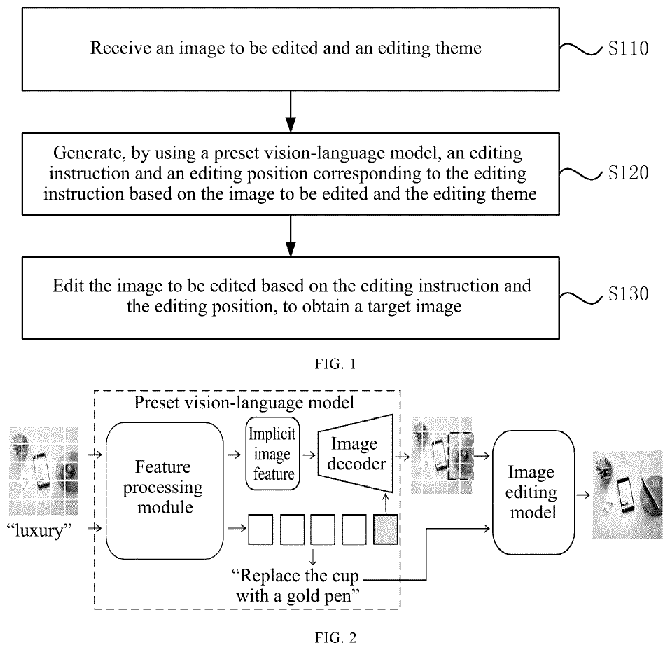

FIG. 1 is a schematic flowchart of an image editing method according to an embodiment of the present disclosure. This embodiment of the present disclosure is applicable to a case that an image is edited based on a fuzzy editing theme. The method may be performed by an image editing apparatus. The apparatus may be implemented in the form of software and/or hardware, and may be configured in an electronic device, for example, in a computer.

As shown in FIG. 1, the image editing method provided in this embodiment may include the following steps.

S110: Receive an image to be edited and an editing theme.

In this embodiment of the present disclosure, the editing theme is different from a specific executable editing instruction in the prior art. The editing theme is not a specific operation performed on a specific object in a specific image, but may be considered as a general high-level editing prompt. Compared with the editing instruction in the prior art, the editing theme may be considered to have a nature of a fuzzy editing purpose. For example, for an image of a puppy, the editing theme may be “luxury”, which does not contain a specific editing operation performed on the puppy in the image, but rather serves as an editing prompt with a fuzzy editing intent.

In this embodiment of the present disclosure, the image editing apparatus may provide a receiving interface for the image and the theme, and input controls for modalities such as image and text may be deployed in the receiving interface, to enable a user to input the image to be edited and the editing theme by triggering the input controls, so that the image to be edited and the editing theme can be received. In addition, other manners of receiving the image to be edited and the editing theme are also applicable here, which are not exhausted herein.

S120: Generate, by using a preset vision-language model, an editing instruction and an editing position corresponding to the editing instruction based on the image to be edited and the editing theme.

In this embodiment of the present disclosure, the editing instruction may be understood as a specific executable instruction that is highly related to the image to be edited and the editing theme. The editing position may be understood as image coordinates of an object related to the editing instruction in the image to be edited, for example, vertex coordinates of a rectangular box containing the related object.

The vision-language model (VLM) may include an image feature processing module and a language feature processing module, which can generate requirement information in combination with multimodal features. In this embodiment of the present disclosure, to enable the preset vision-language model to generate creative and interesting editing instructions related to the image to be edited and the editing theme, an instruction dataset containing tuple data {sample image, sample editing theme, sample editing instruction, object} may be pre-constructed. In each set of tuple data, the object may include a sample target object to be edited in the sample image, and a sample associated object used to perform an editing operation on the sample target object. Moreover, a pre-trained model may be adjusted based on the instruction dataset, to obtain a preset vision-language model capable of intelligently generating editing instructions. The pre-trained model may be understood as a pre-trained VLM model.

In addition, to enable the preset vision-language model to have an ability to predict the editing position, the tuple data may further include an object position of the sample target object. Thus, the adjusted preset vision-language model may have an ability to output the editing position corresponding to the editing instruction. By outputting the editing position, global and/or local image editing may be supported.

The adjusted preset vision-language model may perceive image content of the image to be edited through its internal image feature processing module, and may generate the editing instruction related to the image to be edited and the editing theme through its internal language feature processing module. Moreover, the image feature processing module may further predict the editing position for the editing instruction in combination with the editing instruction and an image feature of the image to be edited, to support global and/or local image editing.

S130: Edit the image to be edited based on the editing instruction and the editing position, to obtain a target image.

In this embodiment of the present disclosure, the generated editing instruction and editing position may be converted into an input format that can be processed by an existing image processing model. Further, the existing image processing model may be used to perform at least local image processing on the image to be edited based on the editing instruction and the editing position, to obtain the target image.

In the prior art, when starting editing a source image, the user usually has a high-level editing intent (i.e., editing theme), which requires an elaborate brainstorming and reasoning process to input specific executable editing instructions in editing software. Such an editing manner cannot easily achieve satisfactory editing results for a user who does not have professional editing experience or who does not have a clear expectation for desired results, resulting in a poor editing experience for the user. In contrast, the technical solution provided in this embodiment of the present disclosure can automatically generate diverse creative editing instructions from a fuzzy editing theme, so that the generated editing instructions conform to both the image content and the editing theme; and can provide the user with diverse editing suggestions and inspire the user's editing creativity, to achieve satisfactory editing results, which can improve the user's editing experience.

In some optional implementations, generating, by using the preset vision-language model, the editing instruction and the editing position corresponding to the editing instruction based on the image to be edited and the editing theme may include:
performing, by using the preset vision-language model, feature extraction on the image to be edited, to obtain an implicit image feature; generating a token sequence of editing instruction based on the image to be edited and the editing theme, where the token sequence includes a spatial token; and decoding the token sequence into the editing instruction, and generating the editing position corresponding to the editing instruction based on the implicit image feature and the spatial token.

The token sequence may be understood as encoding of the editing instruction. In this implementation, to enable the preset vision-language model to have the ability to predict the editing position, the spatial token is introduced into the token sequence during the training and use of the model. The spatial token may be located at the end of the token sequence so that the spatial token may perceive a feature of a preamble editing instruction, to provide clues for predicting a position of an object related to the editing instruction. Accordingly, the preset vision-language model determines the editing position of the object related to the editing instruction in the image to be edited based on the spatial token and the implicit image feature. Moreover, the preset vision-language model may decode the token sequence into the encoded instruction.

For example, FIG. 2 is a schematic block diagram of an image editing method according to an embodiment of the present disclosure. Referring to FIG. 2, the image to be edited and the editing theme “luxury” may be input into the preset vision-language model. The implicit image feature may be output through an image processing part of the feature processing module of the model, and the token sequence of the editing instruction may be output through a language processing part in combination with the implicit image feature and the editing theme. The end position of the token sequence may be considered the spatial token.

Further, an image decoder in the preset vision-language model may be used to determine the editing position of the object related to the editing instruction in the image to be edited in combination with the implicit image feature and the spatial token. As shown in FIG. 2, the editing position may be, for example, a bounding box containing a cup. A structure of the image decoder may include, for example, a mapping layer for the spatial token and a preset number (e.g., 3) of transformer layers, to enable visual localization based on multimodal features.

Generating the editing position corresponding to the editing instruction based on the implicit image feature and the spatial token may include: performing a cross-attention calculation on the implicit image feature and the spatial token, and predicting the editing position corresponding to the editing instruction based on a result of the calculation. By performing the cross-attention calculation on the implicit image feature and the spatial token, it is possible to predict the editing position for the editing instruction based on different modal features. The editing position may be used as guidance for an existing image editing model, for at least local editing in the image to be edited.

In FIG. 2, the token sequence may be decoded into an editing instruction “Replace the cup with a gold pen”. The editing instruction and the editing position may then be converted into the input format (e.g., JSON format) of the image editing model, so that the image editing model can execute the editing instruction to replace the cup in the image to be edited with a gold pen, to match the editing theme.

In these optional implementations, by introducing the spatial token, it is possible to predict an image region to which the editing instruction is applied, and enable text-driven and at least local image editing, which achieves flexibility in editing.

In some optional implementations, after the generating an editing instruction and an editing position corresponding to the editing instruction, the method may further include: receiving a selection operation for a target editing instruction, to determine the target editing instruction from at least two editing instructions.

There may be at least one editing instruction, and accordingly, there may be at least one corresponding editing position. Moreover, the editing instruction may include a local instruction or a global instruction. The global instruction may be, for example, an instruction to change the background, adjust a filter, etc. An editing position corresponding to the global instruction may be the entire image. For example, for an image of a puppy with an editing theme “luxury”, the generated editing instruction may be, for example, “Replace the image background with a high-end lobby”.

In these optional implementations, the image editing apparatus may further provide a selection interface for editing instructions, through which the selection operation for the target editing instruction input by the user may be received. Moreover, at least one target editing instruction may be determined based on the selection operation, where target editing instructions are mutually exclusive with respect to an object to be edited. For example, referring again to FIG. 2, assuming that the editing instructions include “Replace the cup with a gold pen” and “Replace the cup with a gold watch,” both of which are related to the same object to be edited, therefore, only one of the two editing instructions may be selected as the target editing instruction. However, for different objects to be edited, a plurality of target editing instructions may be selected.

In addition, in a case that these editing instructions inspire the user's new editing creativity, the user may also input a custom editing instruction through the selection interface to use it as the target editing instruction. This not only provides the user with diverse editing suggestions, but also inspires the user's editing creativity, which can improve the user's editing experience.

In some optional implementations, after the generating an editing instruction and an editing position corresponding to the editing instruction, the method may further include: receiving an adjustment operation for the editing position, to adjust the editing position.

In these optional implementations, the image editing apparatus may further provide an adjustment interface for the editing position corresponding to the editing instruction, so as to receive the user adjustment operation for the editing position through the adjustment interface when the user is not satisfied with the editing position, thereby further meeting the user's editing experience.

This technical solution of the embodiment of the present disclosure involves receiving an image to be edited and an editing theme; generating, by using a preset vision-language model, an editing instruction and an editing position corresponding to the editing instruction based on the image to be edited and the editing theme; and editing the image to be edited based on the editing instruction and the editing position, to obtain a target image. By generating the creative editing instruction that is highly related to the image to be edited and the editing theme, and predicting the editing position corresponding to the editing instruction, it is possible to perform at least local creative editing on the image to be edited based on a fuzzy editing theme.

This embodiment of the present disclosure may be combined with various optional solutions in the image editing method provided in the above embodiment. The image editing method provided in this embodiment describes in detail the construction of the instruction dataset. By extracting a detailed list of visual elements present in the sample image, a full visual understanding of the sample image can be achieved. By providing a list of associated objects related to the sample editing theme, the language model may be prompted to imagine around the sample editing theme. By using the list of visual elements and the list of associated objects, the language model may be prompted to generate diverse creative editing instructions. By using element combination data containing the sample image, the sample editing theme, the sample editing instruction, the sample associated object, the sample target object, and the object position of the sample target object as sample data in the instruction dataset, to adjust the pre-trained model to the preset vision-language model, the preset vision-language model may have functions of generating the creative editing instructions and predicting the editing positions, which lays a foundation for image editing under a fuzzy editing theme.

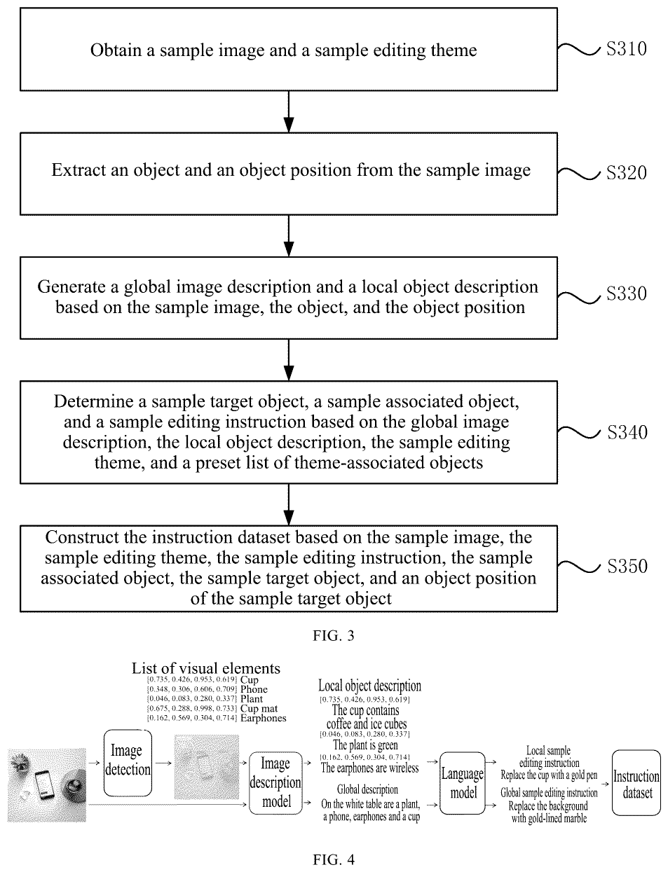

FIG. 3 is a schematic flowchart of constructing an instruction dataset in an image editing method according to an embodiment of the present disclosure. As shown in FIG. 3, in the image editing method provided in this embodiment, the preset vision-language model includes a pre-trained model adjusted based on an instruction dataset. A construction process of the instruction dataset includes the following steps.

S310: Obtain a sample image and a sample editing theme.

In this embodiment, obtaining the sample image and the sample editing theme shall comply with the requirements of corresponding laws, regulations, and relevant provisions.

S320: Extract an object and an object position from the sample image.

For example, FIG. 4 is a schematic block diagram of constructing an instruction dataset in an image editing method according to an embodiment of the present disclosure. Referring to FIG. 4, a detailed list of visual elements present in the sample image may first be extracted to achieve a full visual understanding. In FIG. 4, an existing image detection algorithm may be used to extract an open world category and object position (e.g., a rectangular box containing the object) of each object in the sample image. For example, in FIG. 4, results of the detection may include “[0.735, 0.426, 0.953, 0.619] Cup”, etc., where content within [ ] may be normalized pixel coordinates of the upper-left and lower-right corners of a detection box to which the object belongs.

S330: Generate a global image description and a local object description based on the sample image, the object, and the object position.

An existing image description model may be used to generate the local object description and the global description of the entire image based on the sample image, the object, and the object position. This process helps to convert an image with rich fine granularity into a textual representation. As in FIG. 4, the generated description may include a local object description of “Cup”, such as “The cup contains coffee and ice cubes”.

S340: Determine a sample target object, a sample associated object, and a sample editing instruction based on the global image description, the local object description, the sample editing theme, and a preset list of theme-associated objects.

In this embodiment, the sample target object is contained in the sample image, the sample associated object is contained in the list of theme-associated objects, and the sample editing instruction is used to describe an editing operation performed on the sample target object based on the sample associated object.

The preset list of theme-associated objects is a pre-generated list of objects related to the sample editing theme. For example, for the sample editing theme “luxury”, the associated objects may include gold necklaces, luxury homes, high-end lobbies, etc. To this end, given image content and a sample editing theme, an existing language model may be prompted based on the list of theme-associated objects to imagine around the sample editing theme, thereby generating the sample target object, the sample associated object, and the sample editing instruction. In addition, the language model may further be prompted to provide a reason for each sample associated object to ensure its rationality. For example, in FIG. 4, the generated sample editing instruction may include the global instruction “Replace the background with gold inlaid marble”.

S350: Construct the instruction dataset based on the sample image, the sample editing theme, the sample editing instruction, the sample associated object, the sample target object, and an object position of the sample target object.

In this embodiment, a set of the sample image, the sample editing theme, the sample editing instruction, the sample associated object, the sample target object, and the object position of the sample target object may be used as tuple data. Massive tuple data may be stored in a dataset to construct the instruction dataset. The instruction dataset may include local sample editing instructions or global sample editing instructions.

In some optional implementations, after the determination of the sample editing instruction, the method may further include: editing the sample image according to the sample editing instruction, to obtain a sample target image; and filtering the sample editing instruction based on a similarity between the sample target image and the sample editing theme.

In these optional implementations, whether the sample editing instruction is acceptable for the image editing model is very important, and thus the sample image may be edited by the image editing model according to the sample editing instruction. Based on an existing algorithm for determining an image-text similarity, the similarity between the sample target image and the sample editing theme is determined. Further, sample editing instructions with the similarity below a preset threshold (e.g, 0.4) may be filtered out to ensure the quality of the sample editing instructions.

In addition, other processing operations may further be performed on the instruction dataset, such as a tuple data deduplication operation. Moreover, for local editing, the user-input selecting instructions may be used to select editing instructions that are simple enough to ensure a clear editing result.

This embodiment of the present disclosure constructs the instruction dataset by simulating a process of human creative reasoning. This dataset is used as the basis for adjusting to obtain the preset vision-language model, allowing the preset vision-language model to recommend a variety of creative editing instructions that are customized to visual content of the image and the editing theme provided by the user.

This technical solution of the embodiment of the present disclosure describes in detail the construction of the instruction dataset. By extracting a detailed list of visual elements present in the sample image, a full visual understanding of the sample image can be achieved. By providing a list of associated objects related to the sample editing theme, the language model may be prompted to imagine around the sample editing theme. By using the list of visual elements and the list of associated objects, the language model may be prompted to generate diverse creative editing instructions. By using element combination data containing the sample image, the sample editing theme, the sample editing instruction, the sample associated object, the sample target object, and the object position of the sample target object as sample data in the instruction dataset, to adjust the pre-trained model to the preset vision-language model, the preset vision-language model may have functions of generating the creative editing instructions and predicting the editing positions, which lays a foundation for image editing under a fuzzy editing theme.

Furthermore, the image editing method provided in this embodiment of the present disclosure and the image editing method provided in the above embodiment belong to the same concept of disclosure. For the technical details not described in detail in this embodiment, reference can be made to the above embodiment, and the same technical features have the same beneficial effects in this embodiment and the above embodiment.

FIG. 5 is a schematic diagram of a structure of an image editing apparatus according to an embodiment of the present disclosure. The image editing apparatus provided in this embodiment is applicable to a case that an image is edited based on a fuzzy editing theme.

As shown in FIG. 5, the image editing apparatus provided in this embodiment of the present disclosure may include:
a receiving module 510 configured to receive an image to be edited and an editing theme;
a generation module 520 configured to generate, by using a preset vision-language model, an editing instruction and an editing position corresponding to the editing instruction based on the image to be edited and the editing theme; and
an editing module 530 configured to edit the image to be edited based on the editing instruction and the editing position, to obtain a target image.

In some optional implementations, the preset vision-language model includes a pre-trained model adjusted based on an instruction dataset. The image editing apparatus may further include:
a dataset construction module configured to construct an instruction dataset based on the following construction process:
obtaining a sample image and a sample editing theme;
extracting an object and an object position from the sample image;
generating a global image description and a local object description based on the sample image, the object, and the object position;
determining a sample target object, a sample associated object, and a sample editing instruction based on the global image description, the local object description, the sample editing theme, and a preset list of theme-associated objects;
where the sample target object is contained in the sample image, the sample associated object is contained in the list of theme-associated objects, and the sample editing instruction is used to describe an editing operation performed on the sample target object based on the sample associated object; and
constructing the instruction dataset based on the sample image, the sample editing theme, the sample editing instruction, the sample associated object, the sample target object, and an object position of the sample target object.

In some optional implementations, after the determination of the sample editing instruction, the dataset construction module may further be configured to:
edit the sample image according to the sample editing instruction, to obtain a sample target image; and
filter the sample editing instruction based on a similarity between the sample target image and the sample editing theme.

In some optional implementations, the generation module may be configured to:
perform, by using the preset vision-language model, feature extraction on the image to be edited, to obtain an implicit image feature;
generate a token sequence of the editing instruction based on the image to be edited and the editing theme, where the token sequence includes a spatial token; and
decode the token sequence into the editing instruction, and generate the editing position corresponding to the editing instruction based on the implicit image feature and the spatial token.

In some optional implementations, the generation module may be configured to:
perform a cross-attention calculation on the implicit image feature and the spatial token, and predict the editing position corresponding to the editing instruction based on a result of the calculation.

In some optional implementations, the image editing apparatus may further include:
a selection module configured to: after the editing instruction and the editing position corresponding to the editing instruction are generated, receive a selection operation for a target editing instruction, to determine the target editing instruction from at least two editing instructions.

In some optional implementations, the image editing apparatus may further include:
an adjustment module configured to: after the editing instruction and the editing position corresponding to the editing instruction are generated, receive an adjustment operation for the editing position, to adjust the editing position.

The image editing apparatus provided in this embodiment of the present disclosure can perform the image editing method provided in any embodiment of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

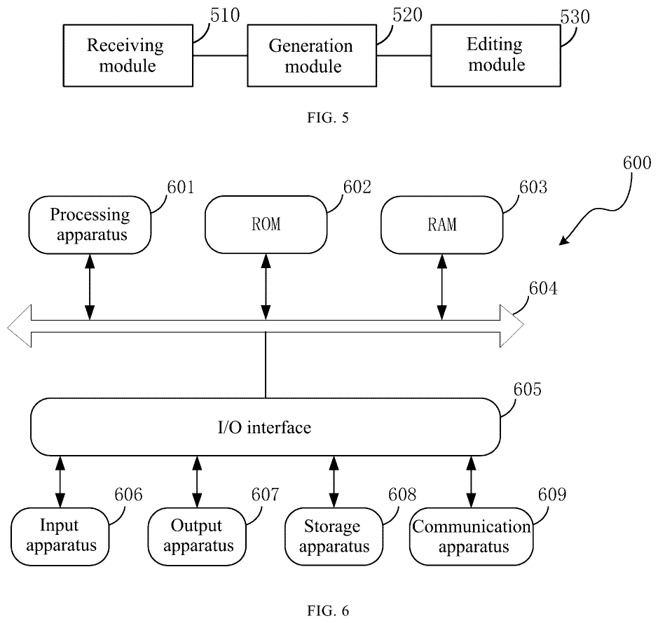

Reference is made to FIG. 6 below, which is a schematic diagram of a structure of an electronic device (such as a terminal device or a server in FIG. 6) 600 suitable for implementing embodiments of the present disclosure. The terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 600 may include a processing apparatus (e.g., a central processing unit, a graphics processing unit, etc.) 601 that may perform a variety of appropriate actions and processing in accordance with a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 609, installed from the storage apparatus 608, or installed from the ROM 602. When the computer program is executed by the processing apparatus 601, the above-mentioned functions defined in the image editing method of the embodiment of the present disclosure are performed.

The electronic device provided in this embodiment of the present disclosure and the image editing methods provided in the above embodiments belong to the same concept of disclosure. For the technical details not described in detail in this embodiment, reference can be made to the above embodiments, and this embodiment and the above embodiments have the same beneficial effects.

This embodiment of the present disclosure provides a computer storage medium having stored thereon a computer program that, when executed by a processor, causes the image editing methods provided in the above embodiments to be implemented.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electric connection with one or more wires, a portable computer disk, a hard disk, a random access memory (RAM), a read only memory (ROM), an erasable programmable read-only memory (EPROM) or a flash memory (FLASH), an optical fiber, a portable compact disc read only memory (CD-ROM), an optical storage device, a magnetic storage device, or any appropriate combination of the above. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server may communicate using any currently known or future-developed network protocol such as a Hypertext Transfer Protocol (HTTP), and may be connected to digital data communication (for example, communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to:
receive an image to be edited and an editing theme; generating, by using a preset vision-language model, an editing instruction and an editing position corresponding to the editing instruction based on the image to be edited and the editing theme; and editing the image to be edited based on the editing instruction and the editing position, to obtain a target image.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The names of the units and the modules do not constitute a limitation on the units and the modules themselves under certain circumstances.

The functions described herein above may be performed at least partially by one or more hardware logic components. For example, without limitation, exemplary types of hardware logic components that may be used include: a field programmable gate array (FPGA), an application specific integrated circuit (ASIC), application specific standard parts (ASSPs), a system on chip (SOC), a complex programmable logic device (CPLD), etc.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, an image editing method is provided. The method includes:
receiving an image to be edited and an editing theme;
generating, by using a preset vision-language model, an editing instruction and an editing position corresponding to the editing instruction based on the image to be edited and the editing theme; and
editing the image to be edited based on the editing instruction and the editing position, to obtain a target image.

According to one or more embodiments of the present disclosure, the image editing method is provided, further including the following.

In some optional implementations, the preset vision-language model includes a pre-trained model adjusted based on an instruction dataset. A construction process of the instruction dataset includes:
obtaining a sample image and a sample editing theme;
extracting an object and an object position from the sample image;
generating a global image description and a local object description based on the sample image, the object, and the object position;
determining a sample target object, a sample associated object, and a sample editing instruction based on the global image description, the local object description, the sample editing theme, and a preset list of theme-associated objects;
where the sample target object is contained in the sample image, the sample associated object is contained in the list of theme-associated objects, and the sample editing instruction is used to describe an editing operation performed on the sample target object based on the sample associated object; and constructing the instruction dataset based on the sample image, the sample editing theme, the sample editing instruction, the sample associated object, the sample target object, and an object position of the sample target object.

According to one or more embodiments of the present disclosure, the image editing method is provided, further including the following.

In some optional implementations, after the determination of the sample editing instruction, the method further includes:
editing the sample image according to the sample editing instruction, to obtain a sample target image; and
filtering the sample editing instruction based on a similarity between the sample target image and the sample editing theme.

According to one or more embodiments of the present disclosure, the image editing method is provided, further including the following.

In some optional implementations, the generating, by using a preset vision-language model, an editing instruction and an editing position corresponding to the editing instruction based on the image to be edited and the editing theme includes:
performing, by using the preset vision-language model, feature extraction on the image to be edited, to obtain an implicit image feature;
generating a token sequence of the editing instruction based on the image to be edited and the editing theme, where the token sequence includes a spatial token; and
decoding the token sequence into the editing instruction, and generating the editing position corresponding to the editing instruction based on the implicit image feature and the spatial token.

According to one or more embodiments of the present disclosure, the image editing method is provided, further including the following.

In some optional implementations, the generating the editing position corresponding to the editing instruction based on the implicit image feature and the spatial token includes:
performing a cross-attention calculation on the implicit image feature and the spatial token, and predicting the editing position corresponding to the editing instruction based on a result of the calculation.

According to one or more embodiments of the present disclosure, the image editing method is provided, further including the following.

In some optional implementations, after the generating an editing instruction and an editing position corresponding to the editing instruction, the method further includes:
receiving a selection operation for a target editing instruction, to determine the target editing instruction from at least two editing instructions.

According to one or more embodiments of the present disclosure, the image editing method is provided, further including the following.

In some optional implementations, after the generating an editing instruction and an editing position corresponding to the editing instruction, the method further includes: receiving an adjustment operation for the editing position, to adjust the editing position.

According to one or more embodiments of the present disclosure, an image editing apparatus is provided. The apparatus includes:
a receiving module configured to receive an image to be edited and an editing theme;
a generation module configured to generate, by using a preset vision-language model, an editing instruction and an editing position corresponding to the editing instruction based on the image to be edited and the editing theme; and
an editing module configured to edit the image to be edited based on the editing instruction and the editing position, to obtain a target image.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. An image editing method, comprising:
receiving an image to be edited and an editing theme;
generating, by using a preset vision-language model, an editing instruction and an editing position corresponding to the editing instruction based on the image to be edited and the editing theme; and
editing the image to be edited based on the editing instruction and the editing position, to obtain a target image.

2. The method according to claim 1, wherein the preset vision-language model comprises a pre-trained model adjusted based on an instruction dataset; and wherein a construction process of the instruction dataset comprises:
obtaining a sample image and a sample editing theme;
extracting an object and an object position from the sample image;
generating a global image description and a local object description based on the sample image, the object, and the object position;
determining a sample target object, a sample associated object, and a sample editing instruction based on the global image description, the local object description, the sample editing theme, and a preset list of theme-associated objects;
wherein the sample target object is contained in the sample image, the sample associated object is contained in the list of theme-associated objects, and the sample editing instruction is used to describe an editing operation performed on the sample target object based on the sample associated object; and
constructing the instruction dataset based on the sample image, the sample editing theme, the sample editing instruction, the sample associated object, the sample target object, and an object position of the sample target object.

3. The method according to claim 2, wherein after the determination of the sample editing instruction, the method further comprises:
editing the sample image according to the sample editing instruction, to obtain a sample target image; and
filtering the sample editing instruction based on a similarity between the sample target image and the sample editing theme.

4. The method according to claim 1, wherein the generating, by using a preset vision-language model, an editing instruction and an editing position corresponding to the editing instruction based on the image to be edited and the editing theme comprises:
performing, by using the preset vision-language model, feature extraction on the image to be edited, to obtain an implicit image feature;
generating a token sequence of the editing instruction based on the image to be edited and the editing theme, wherein the token sequence comprises a spatial token; and
decoding the token sequence into the editing instruction, and generating the editing position corresponding to the editing instruction based on the implicit image feature and the spatial token.

5. The method according to claim 4, wherein the generating the editing position corresponding to the editing instruction based on the implicit image feature and the spatial token comprises:
performing a cross-attention calculation on the implicit image feature and the spatial token, and predicting the editing position corresponding to the editing instruction based on a result of the calculation.

6. The method according to claim 1, wherein after the generating an editing instruction and an editing position corresponding to the editing instruction, the method further comprises:
receiving a selection operation for a target editing instruction, to determine the target editing instruction from at least two editing instructions.

7. The method according to claim 1, wherein after the generating an editing instruction and an editing position corresponding to the editing instruction, the method further comprises:
receiving an adjustment operation for the editing position, to adjust the editing position.

8. An electronic device, comprising:
one or more processors; and
a storage apparatus configured to store one or more programs, wherein
the one or more programs, when executed by the one or more processors, cause the one or more processors to:
receive an image to be edited and an editing theme;
generate, by using a preset vision-language model, an editing instruction and an editing position corresponding to the editing instruction based on the image to be edited and the editing theme; and
edit the image to be edited based on the editing instruction and the editing position, to obtain a target image.

9. The electronic device according to claim 8, wherein the preset vision-language model comprises a pre-trained model adjusted based on an instruction dataset; and wherein the one or more programs for a construction process of the instruction dataset further comprise one or more programs which, when executed by the one or more processors, cause the one or more processors to:
obtain a sample image and a sample editing theme;
extract an object and an object position from the sample image;
generate a global image description and a local object description based on the sample image, the object, and the object position;
determine a sample target object, a sample associated object, and a sample editing instruction based on the global image description, the local object description, the sample editing theme, and a preset list of theme-associated objects;
wherein the sample target object is contained in the sample image, the sample associated object is contained in the list of theme-associated objects, and the sample editing instruction is used to describe an editing operation performed on the sample target object based on the sample associated object; and
construct the instruction dataset based on the sample image, the sample editing theme, the sample editing instruction, the sample associated object, the sample target object, and an object position of the sample target object.

10. The electronic device according to claim 9, wherein after the determination of the sample editing instruction, the one or more programs further cause the one or more processors to:
edit the sample image according to the sample editing instruction, to obtain a sample target image; and
filter the sample editing instruction based on a similarity between the sample target image and the sample editing theme.

11. The electronic device according to claim 8, wherein the one or more programs for the generating, by using a preset vision-language model, an editing instruction and an editing position corresponding to the editing instruction based on the image to be edited and the editing theme further comprise one or more programs which, when executed by the one or more processors, cause the one or more processors to:
perform, by using the preset vision-language model, feature extraction on the image to be edited, to obtain an implicit image feature;
generate a token sequence of the editing instruction based on the image to be edited and the editing theme, wherein the token sequence comprises a spatial token; and
decode the token sequence into the editing instruction, and generate the editing position corresponding to the editing instruction based on the implicit image feature and the spatial token.

12. The electronic device according to claim 11, wherein the one or more programs for the generating the editing position corresponding to the editing instruction based on the implicit image feature and the spatial token further comprise one or more programs which, when executed by the one or more processors, cause the one or more processors to:
perform a cross-attention calculation on the implicit image feature and the spatial token, and predict the editing position corresponding to the editing instruction based on a result of the calculation.

13. The electronic device according to claim 8, wherein after the generating an editing instruction and an editing position corresponding to the editing instruction, the one or more programs further cause the one or more processors to:
receive a selection operation for a target editing instruction, to determine the target editing instruction from at least two editing instructions.

14. The electronic device according to claim 8, wherein after the generating an editing instruction and an editing position corresponding to the editing instruction, the one or more programs further cause the one or more processors to:
receive an adjustment operation for the editing position, to adjust the editing position.

15. A non-transitory storage medium containing computer-executable instructions, wherein the computer-executable instructions, when executed by a computer processor, are used to:
receive an image to be edited and an editing theme;
generate, by using a preset vision-language model, an editing instruction and an editing position corresponding to the editing instruction based on the image to be edited and the editing theme; and
edit the image to be edited based on the editing instruction and the editing position, to obtain a target image.

16. The non-transitory storage medium according to claim 15, wherein the preset vision-language model comprises a pre-trained model adjusted based on an instruction dataset; and wherein the computer-executable instructions used for a construction process of the instruction dataset further comprise computer-executable instructions which, when executed by the computer processor, are used to:
obtain a sample image and a sample editing theme;
extract an object and an object position from the sample image;
generate a global image description and a local object description based on the sample image, the object, and the object position;
determine a sample target object, a sample associated object, and a sample editing instruction based on the global image description, the local object description, the sample editing theme, and a preset list of theme-associated objects;
wherein the sample target object is contained in the sample image, the sample associated object is contained in the list of theme-associated objects, and the sample editing instruction is used to describe an editing operation performed on the sample target object based on the sample associated object; and
construct the instruction dataset based on the sample image, the sample editing theme, the sample editing instruction, the sample associated object, the sample target object, and an object position of the sample target object.

17. The non-transitory storage medium according to claim 16, wherein after the determination of the sample editing instruction, the computer-executable instructions are further used to:
edit the sample image according to the sample editing instruction, to obtain a sample target image; and
filter the sample editing instruction based on a similarity between the sample target image and the sample editing theme.

18. The non-transitory storage medium according to claim 15, wherein the computer-executable instructions used for the generating, by using a preset vision-language model, an editing instruction and an editing position corresponding to the editing instruction based on the image to be edited and the editing theme further comprise computer-executable instructions which, when executed by the computer processor, are used to:
perform, by using the preset vision-language model, feature extraction on the image to be edited, to obtain an implicit image feature;
generate a token sequence of the editing instruction based on the image to be edited and the editing theme, wherein the token sequence comprises a spatial token; and
decode the token sequence into the editing instruction, and generate the editing position corresponding to the editing instruction based on the implicit image feature and the spatial token.

19. The non-transitory storage medium according to claim 18, wherein the computer-executable instructions used for the generating the editing position corresponding to the editing instruction based on the implicit image feature and the spatial token further comprise computer-executable instructions which, when executed by the computer processor, are used to:
perform a cross-attention calculation on the implicit image feature and the spatial token, and predict the editing position corresponding to the editing instruction based on a result of the calculation.

20. The non-transitory storage medium according to claim 15, wherein after the generating an editing instruction and an editing position corresponding to the editing instruction, the computer-executable instructions are further used to:
receive a selection operation for a target editing instruction, to determine the target editing instruction from at least two editing instructions.
